(19) United States
(12) Patent Application Publication
(10) Pub. No.: US 2012/0295057 A1
(43) Pub. Date: Nov. 22, 2012

(54) Multi-layer material comprising impregnated and axially-oriented fiber fabrics; ballistic resistance, stab resistance and anti-trauma; manufacturing method and protection garment produced thereby.

(75) Inventor: Alberto Atorrasagasti, San Isidro (AR)

(73) Assignee: MULTI AXIAL, LLC, Pembroke Pines, FL (US)

(21) Appl. No.: 13/466,227

(22) Filed: May 8, 2012

Related U.S. Application Data
(60) Provisional application No. 61/486,743, filed on May 16, 2011.

(51) Int. Cl. F41H 1/02; B32B 5/26

(52) U.S. Cl. 428/101; 428/113

(57) ABSTRACT

Multi-layer non-woven fabric material composed of non-woven fiber sheets of aramide/polyethylene fibers, impregnated with resin and/or a filler material, and oriented at various angles, which is used for manufacturing protection garments. The multi-layered non-woven fabric material may also include a foam membrane backing to serve as an anti-trauma mechanism. The invention also describes a method for manufacturing said multi-layer non-woven fabric material and the protection garments thus obtained from a commercially available material, an “in house” equivalent, or the discarded leftover portions of either the commercially available material or the “in house” equivalent material that is not commercially available.

### CROSS-REFERENCES

None

### GOVERNMENT RIGHTS NONE

Other Publications None

### BACKGROUND OF INVENTION

1. Field of Invention

The present invention relates to a multi-layer material anti-trauma material composed of fabrics made of impregnated fibers axially-oriented at specific angles, impregnated with a resin and/or filler material and incorporating an energy absorbing anti-trauma foam membrane backing. Said material is used in the manufacture of multi-threat body armors, for example vests and any other kind of garment, which are shrapnel-proof, stab-proof and against the penetration of piercing and cutting objects.

2. Description of the Related Art

In order to provide personal protection against projectiles or piercing objects, special fabrics or layers are used for the manufacture of body armors, vests, helmets, shields, and any kind of safety and protection garment, for both industrial and sports purposes. Said layers and fabrics can be manufactured from fibers such as aramide, high molecular weight polyethylene and polybenzazoles. Said materials are disclosed in, for example, U.S. Pat. No. 7,073,538B2 to Bhatnagar published on Jul. 11, 2006, U.S. Pat. No. 7,288,307B2 to Bhatnagar published on Oct. 30, 2007, US 2001/0053645A1 to Henderson published on Dec. 20, 2001, US 2006/0121805A1 to Krulic, published on Jun. 8, 2006, and in the International Patent Application PCT WO 2008/101138A1 to Bhatnagar, published on Aug. 21, 2008 as well as in Patent ES 2187013.

Said articles exhibit various degrees of resistance against the penetration of knives and in general of projectiles of any kind. High-strength fibers made of Ultra High Molecular Weight Polyethylene (UHMW PE), aramides and polybenzazoles are incorporated into these materials under various forms, either as hybrid compositions (mixtures of polyethylene and aramides, woven or non woven), rigid compositions (prepared by bonding of fabrics under pressure) or flexible compositions. Fibers in a non-woven layer can be oriented in a single direction 0°/90°, typically containing a matrix resin to stabilize the structure.

Another known procedure comprises rotating the fabrics so that they will bear an angular relation of 0°/90° or 0°/45°/90°/45/90° to each other, or in different angles, for the purpose of constructing rigid or moderately flexible materials, by bonding fabrics under heat and pressure, so that the matrixes of individual layers become bonded into a single matrix of high mechanical strength, suitable for construction. The material thus obtained is characterized by such rigidity that, although it can be used with excellent results in armored structures, it is difficult to use in body armors, due to its limited flexibility.

None of the above mentioned references discloses a material such as the one disclosed in the present invention, which comprises non-woven fabrics or layers individually impregnated and superimposed so that the fibers in each layer of fabric form angles of 0°/90°, +45°, −45°, 0°/90°, +45°, −45°, 0°/90° and so on with the fibers of the adjacent layer or fabric. As many fabrics as desired can be superimposed, depending on the intended purpose of the material, the superimposed layers or fabrics are not bonded or glued together; therefore a flexible material is obtained, ideally suited for its use in garments. The protection garments manufactured with the multi-layer material of the invention, besides having greater flexibility, achieve an optimum resistance to penetration by projectiles, but also, and most remarkably, are more resistant to penetration by piercing objects than the state-of-the-art materials.

### SUMMARY OF INVENTION

In a first embodiment, the object of the invention comprises a non-woven/UD band comprised by a first set of unidirectional, continuous threads/filaments, laid down in a first plane of UHMWPE 1000 and a second set of unidirectional continuous threads/filaments on top of said first plane laid down transversely in different angles to the first set of threads. By applying different information techniques, the drawing ratio (% elongation at break), ASTM D-638 and DIN 53455 in a percentage value of UHMW/PE 1000 of 350, as well as the elasticity module (kg/cm2 tension) ASTM D-638 and DIN 53457 in a tension value of UHMW/PE 1000 of 6000 may be achieved.

In the case of aramid fibers made up from aromatic polyamides filed in U.S. Pat. No. 3,671,542, with different formulas, will give a tenacity of 23 g/denier, 203 cN/tex/424000 psi, 2920 Mpa, 1500 denier/1670 dtex. For example, poly (p-phenylene terephthalamide), filament's produced by DuPont®, under the trademark KEVLAR® used in the formation of different composites resistant to ballistic impact and whose commercial denomination is KEVLAR® 29/129 are compatible for use in this invention. Also, the poly(m-phenylene isophthalamide) fibers (whose commercial denomination is NOMEX®) produced by DuPont® are also compatible for this invention.

In accordance with the teachings of this invention as embodied and described herein, an improved multi-layer anti-trauma non-woven fabric material composed of multiple non-woven fabric layers or laminates each made up of individually impregnated unidirectional fiber sheets and superimposed so that the fibers in each layer of non-woven fabric form various angles of 0° to 90°, including but not limited to 20°, 25°, 30°, 35°, 40°, 45°, 50°, 55°, 60°, 65°, 70°, 75°, 80°, and 90° and so on with the fibers of the adjacent layer or non-woven fabric. Each layer is impregnated with a resin and/or filler material and incorporates an anti-trauma foam membrane backing. As many non-woven fabric layers as desired can be superimposed, depending on the intended purpose of the material. The superimposed non-woven fabric layers are not bonded or glued together only joined at the ends; therefore a flexible material is obtained, ideally suited for its use in garments. The protection garments manufactured with the multi-layer non-woven fabric material of the invention, in addition to having greater flexibility, achieve an optimum resistance to penetration by projectiles, and also, most remarkably, are more resistant to penetration by piercing objects than the state-of-the-art materials.

The present invention, which comprises non-woven fabric layers individually impregnated with a resin material. Each non-woven fabric layer is superimposed so that the fibers in each layer form angles of 0°/90°, 0°/20°, 0°/25°, 0°/30°, 0°/35°, 0°/40°, 0°/45°, 0°/50°, 0°/55°, 0°/60°, 0°/65°, 0°/70°, 0°/75°, 0°/80° with the fibers of the adjacent layer. As many non-woven fabric layers as desired can be superimposed, depending on the intended purpose of the material (i.e. fewer layers for flexibility and more layers for rigidity). The superimposed non-woven fabric layers are not bonded or glued together; therefore a flexible material is obtained, ideally suited for its use in garments. The protection garments manufactured with the multi-layer non-woven fabric material of the invention, in addition to having greater flexibility, achieve an optimum resistance to penetration by projectiles, and also, most remarkably, (due to the incorporation of the resin impregnation) are more resistant to penetration by piercing objects than the state-of-the-art materials.

It is evident that the multi-axial band of the invention may be composed of a larger quantity of intermediate planes and/or different rotation angles between the planes of yarns which are illustrated in the figures. For the purposes of this invention, the fiber is dimensionally elongated in its length, being larger than the width transversal dimensions. Consequently, the fiber term includes fiber filaments, regular or irregular to the transversal section of different angles.

A thread is a continuous strand composed by many fibers or filaments. The fibers making up the thread may be continuous along the length of the thread or the fibers. The threads of unidirectional continuous filaments are the main structural components of the unidirectional band in different multi-axial angles of the invention. The threads of unidirectional continuous filaments may be incorporated into the material in different fibers independently formed in groups by: polyolefins of high molecular weight, aramids, polybenzazoles and/or a mixture thereof.

### BRIEF DESCRIPTION OF THE INVENTION

A first object of the present invention is to provide a multi-layer material composed of multiple flexible fabrics made of axially oriented fibers wherein said fabrics are superimposed so that the fibers in one fabric form a certain angle with the fibers in adjacent fabrics.

A second object of the present invention is to provide a flexible multi-layer material wherein the fabrics made of axially oriented fibers are impregnated with a resin.

A third object of the present invention is to provide a flexible multi-layer material wherein the fabrics made of axially oriented fibers are impregnated with a resin and as well as a filler material.

A fourth object of the present invention is the incorporation of foam membrane backing to the multi-layered non-woven fabric composition to act as an anti-trauma agent.

A fifth object of the present invention is the use of the multi-layer material to make body armors or other protection and security garments and elements.

A sixth object of the present invention is to provide a method for manufacturing the flexible material disclosed herein.

A seventh object of the present invention is to provide in the method for manufacturing the flexible material disclosed the use of a commercially available pre-impregnated starting material.

A eighth object of the present invention is to provide in the method for manufacturing the flexible material disclosed, a pre-impregnated, in house starting material.

A ninth object of the present invention is to provide in the method for manufacturing the flexible material disclosed, the construction and use of a new pre-impregnated roll of starting material from the discarded leftovers of the sixth and/or seventh objects.

### BRIEF DESCRIPTION OF DRAWINGS

FIG. 1 is a top perspective view of a cutting table for placing a fabric and where respective cuts have been made to conform the cutting patterns.

FIG. 2 is a top perspective view of the orientation angle of the fibers when the cutting pattern is placed in a first position.

FIG. 3 is a top perspective view of the orientation angle of the fibers when the cutting pattern is placed in a second position.

FIG. 4 is a top perspective view of the orientation angle of the fibers when the cutting pattern is placed in a third position but coincident with the first cutting position.

FIG. 5 is a top perspective view of the orientation angle of the fibers when the cutting pattern is placed in a fourth position but coincident with the second cutting position.

FIG. 6 is a top perspective view of the different pieces showing their fibers oriented at different angles resulting from the different cutting positions and the result of superimposing said pieces of cut material.

FIGS. 7-10 are top perspective views of the sequence illustrating the way in which, by displacing the cutting position longitudinally along the cutting table, patterns are generated with fibers oriented at different angles that, when superimposed to each other, form the multi-layer material of the invention.

### DETAILED DESCRIPTION OF THE INVENTION

It is defined here that fiber is to be understood to mean a longitudinally extended series of filaments, microfilaments, ribbons, threads, strips, films, or the like having a regular or irregular cross section with the length of said fiber being substantially longer than the width and thickness. It is also to be understood that a prepreg, fiber sheet, or unidirectional fiber sheet refers to that which is being constructed from a series of parallel fibers joined together through gluing and possibly to be pre-impregnated with a resin. The majority of the fibers comprising the matrix structure are to be parallel to each other. The matrix, matrix composite, laminate, or non-woven fabric layer structure disclosed is the joining of two or more different fiber sheets through varying angles. Finally a multi-layer non-woven fabric is to be understood to mean the non adhesive joining of the ends of two or more non-woven fabric layers through varying angles.

In one of its preferred embodiments, the material of the present invention is prepared with non-woven fabrics or aramide/polyethylene fiber sheets supplied in rolls called “prepreg”, which are slightly pre-impregnated with a resin, to consolidate the structure of the fiber non-woven fabric at 0°/90°, thus providing it sufficient consistency to be unrolled for handling purposes. Even though the objects of the invention could be achieved with any kind of fiber sheet, as long as said fiber sheet meets the above-mentioned specifications, the fiber sheet used for the invention may be, without limitation, any of the fiber sheets or composites marketed world-wide by the Honeywell company under the trade names GoldShield® GV 2112/GN 2115/GN 2117/GN 2118/GV 2018, Spectra Shield® SR 1214/SRII 3124 y SRII 3130. Further a new roll may be created out of the discarded leftover pieces of the fabrics mentioned above after patterning. Still further it is conceivable that similar fabrics can be manufactured “in house” using appropriate starting materials to create both an initial roll for patterning as well as a second roll made out of the discarded leftover materials of the first patterning. This could also in all cases be done to accommodate any angle thereof.

To said non-woven fabric, resins selected from products in thermally stable laminates, amines, cyanates, epoxies, phenolics, non-saturated polyesters, bismaleimides, polyurethanes, silicones, esters, vinyls and their copolymers and mixtures thereof are incorporated by impregnation under high pressure. Polyurethane resins are particularly preferred. Some trade names of preferred resins are, for example, Baycoll® AS 2060, Desmudur® L 75, Desmophen® 1150 and Desmodur® N75 MPA/BA resins from the Bayer Company, and preferentially the Resinex® 4 resin.

As mentioned above, such chemical compounds (resins) are in general terms applicable to fabrics. However, different resins provide different advantages and results according to specific goals. Resinex® 4 resin performs best for the purposes of the present invention. The impregnation is carried out in a continuous process, under pressures in the range of 100 psi to 1900 psi (6.89 to 131 bars) and at temperatures between 120 and 145° C. (248 and 293° F.). The roll of non-woven fabric is impregnated and later air-dried at elevated temperature.

The features of Resinex® 4 resin are set forth below:

| Properties | Resin | Hardener |
|---|---|---|
| Appearance | Black liquid | Brown liquid |
| Viscosity (at 20° C.) | 3500-5500 mPas | 100-250 mPas |
| Specific Gravity (at 20° C.) | 1.31 | 1.24 |
| Flash Point | >200° C. | >200° C. |

| Properties of the mixture | Test parameters |
|---|---|
| Mixture Ratio (by weight) | 100 resin/25 hardener |
| Gel Time (at 20° C.) | 30-50 minutes |
| Curing Time (at 20° C.) | 24 hours |

| Properties of the cured mixture | Test parameters |
|---|---|
| Specific Gravity | 1.29 |
| Hardness (Shore A) | 92 |
| Tensile Strength | 570 psi |
| Volume shrinkage after curing | 2% |
| Electric Resistance | 11 kV/mm |
| Thermal Conductivity 20-100° C. | 0.4-0.5 W/mK |
| Water Absorption | 0.15-0.2% |

Impregnation with resins causes the microfilaments of threads or aramidic fibers to stick together even more, thus giving the fabric a better structure and obtaining a better control of the displacement of each microfilament in the laminar assembly of the fabric's general structure. The resin incorporated into the fabric by impregnation will bond neighboring filaments all over the fabric area, thus preventing them from displacing when the fabric is penetrated by a piercing or cutting object. In non-woven fabrics of the prior art, the microfilaments of the fibers would displace or be pushed apart, thus allowing any piercing object such as for example a hypodermic syringe to penetrate.

By forming such kind of structure, comprising thread microfibers and impregnating resins binding them, the threads are locked in position and their displacement with respect to their normal orientation angle 0°/90° in non-woven fabrics is reduced by 50% when a projectile or cutting/piercing object penetrates the non-woven fabric, by considerably dissipating its kinetic energy. A completely different result is obtained than with a non-impregnated non-woven fabric.

None of the fabrics of the prior art contains resins as those specified hereinbefore, which differ from those used in pre-impregnation or “prepreg”, so to give the non-woven fabric a structure with a high anti-trauma performance compliant with IIA-II-IIIA levels of NIJ 0101.06 Standard for body armors, and a performance against the penetration of piercing-cutting objects exceeding levels 1, 2 and 3/Spike/P1 and S1 of the NIJ 0115.00 Standard.

In a second embodiment, in addition to impregnating the non-woven fabric sheets with resins as described above, a filler material can be added thereto. The purpose of this procedure is to obtain a better structured material, resistant to piercing objects. The addition is carried out by adding a particulate material selected, without limitation, from the group comprising aluminum oxide, titanium oxide, carbon/boron oxide, silicon oxide, silicon dioxide, quartz oxide, silicon carbide, titanium carbide, hard glass, etc. In a preferred embodiment, the particulate material used is SiO₂. The addition of said particulate material or filler material can be carried out together with the impregnation with resin and before cutting the layers for the manufacture of for example, the body armors, or else can be added after cutting the layers for their intended purpose. The pre-impregnated non-woven fabric used as starting material has a total area density of approximately 107±15 g/m².

If the purpose is to manufacture bullet-proof garments, the starting pre-impregnated fiber sheet will preferably be impregnated only with resins. Impregnation can be carried out on one or both sides of the fiber sheet, depending on the intended result. If resin is applied on only one side of the fiber sheet, the resulting total area density of the non-woven fabric will be of about 125±15 g/m², that is, will increase by about 17% with respect to the initial total area density. If impregnation is made on both sides of the non-woven fabric, the total area density achieved will be of about 138±15 g/m².

If the purpose is to obtain a piercing-proof garment, it is then necessary to impregnate the fiber sheet with resins as well as the filler material. If the resin and the filler material are added on only one side of the non-woven fabric, the total area density will become of 170 g/m², while if resin and filler are applied to both sides of the non-woven fabric, the total area density will become of 234 g/m².

While the quantity of resin applied is the same in the different processes, the quantity of filler material added will determine the number of non-woven fabric layers necessary to form the multi-layer non-woven fabric material; the higher the quantity of filler material added, the lesser will be the number of non-woven fabric layers needed.

To obtain the multi-layer non-woven fabric material of the present invention, besides adding the resins and/or fillers to the non-woven fabrics, the non-woven fabric layers must be oriented in a specific way to obtain a performance against the penetration of bullets, cutting objects and piercing objects in compliance with standards 0101.06 and 0115.00 of the US National Institute of Justice, all in the same product.

Unexpected results have been obtained using non-woven fabrics made of aramide/polyethylene, impregnated with resins and superimposed so that the angle formed by the fibers in two adjacent non-woven fabric layers (or laminate) is different from zero degrees. Such an intercros sing of fiber orientation of adjacent non-woven fabric layers significantly reduces the size of the openings or gaps among the fibers. A smaller opening between fibers is one of the reasons behind the increased resistance of the disclosed material to piercing objects. Undoubtedly, the higher the number of non-woven fabric layers with fibers sheets at different angles, the smaller will be the openings between fibers; hence the penetration by a piercing object will be less probable.

According to the above description, resins were used to impregnate non-woven material made of aramide/polyethylene fiber sheets. The impregnation was carried out after properly placing each of the non-woven fabric sheets, one on top of the other. The incorporation of resins in the impregnation process, allowed decreasing the number of non-woven fabric layers for their testing against a cutting object. The use of a material formed by non-woven fabric layers impregnated with resin and superimposed so that their fibers form a certain angle therebetween, allows an improvement of about 30 to 50% in comparison with a material formed by intercrossed non-impregnated non-woven fabric layers.

The assembly of flexible layers of the invention will not be attached to each other, that is, there will be no adhesive between them, thus forming a material made of multiple non-woven fabrics or multiple layers stacked or superimposed, that will become a part of a protective garment or piece of clothing. The only attachment between such pieces of non-woven fabric will be along the edges of the garment, so as to allow the non-woven fabric to adopt the intended shape of the garment. Said garment or piece of clothing made with the material of the invention, depending on the number of superimposed non-woven fabric layers and the use of resins, will withstand the penetration of cutting/piercing objects in compliance with levels 1, 2 and 3 Spike, P1 and S1 of the NIJ 0115.00 Standard and/or to the penetration of bullets in compliance with protection levels IIA, II and IIIA of NIJ 0.101.06 Standard.

In a third embodiment the object of the present invention may employ an alternate starting material made from the left over pieces of patterned material not used in the first embodiment. Specifically those materials that are discarded after cutting out the pattern used to construct the object of the first embodiment can be further modified and patterned to be used as an alternative starting material to the prepreg roll used in the first embodiment. The construction of the device however will be the same regardless of the use of the prepreg roll or the left over pieces. The various shapes used as an alternate starting material for the construction of the invention include but are not limited to a square, rectangle, triangle, trapezoid, parallelogram, hexagon, and a triangle/rectangle, with each overlapping angles of 0/90, +0/45, −0/45, 0/90.

### Examples

In order to manufacture for example a body armor, cutting patterns are necessary to obtain fabric modules with their fibers oriented in such a way that when superimposed with other fabric modules they will provide a multi-layered fabric vest, where each module has fibers that form a certain angle with respect to the fibers in the adjacent fabric modules of the vest.

The different stages for the manufacture of a bullet-proof and piercing-proof piece of clothing (in this case, a body armor) will be shown below, as well as the way the different impregnated fabric layers are cut to obtain a certain angle of the fibers with each of the cutting patterns, so that when the layers are superimposed on each other, the desired effect of intercrossing and opening reduction between threads is achieved. The preferred intercrossing angle between adjacent fabric layers is of 45°, thereby obtaining minimum and evenly distributed openings between threads.

1) Impregnation with Resins

A roll of non-woven fiber sheet made of aramide/polyethylene fibers (GoldShield GN 2115®/2117-2118/Spectra Shield SR 1224-Spectra Shield II 3124-3130 of Honeywell) with a total area density of 107 g/m² is spread and impregnated on one of its sides with 18-25 g/m² of a polyurethane resin (Rhesinex 4) under a pressure of approximately 146 psi (10 bars) and a temperature of about 130° C. (266° F.). After impregnation with resin, a fiber sheet with a total area density of about 125 g/m² is obtained. The same process is carried out, now impregnating both sides of the fiber sheet instead of just one, thus obtaining a fiber sheet with a total area density of about 138 g/m². Optionally an “in house” equivalent non-woven fabric could be used as an alternative to the use of the Honeywell material. Additionally, (if needed) after impregnating the fabric, about 45 g/m² of particulate filler material, in this case SiO₂, can be applied on the fabric.

### 2) Anti-Trauma Polyester Foam Membrane

The anti-trauma polyethylene foam membrane is coated on one side with a very thin layer of aluminum polyester film or foil, which increases its mechanical resistance, and also boosts its thermal insulation capacity as the metal-faced film refracts body temperature. The 1.60m (width) membrane is adhered to the unidirectional band using a spray system, 3M contact-type adhesive or a similar product with the same characteristics. Once the membrane is built into the unidirectional band, after it is adhered to it, a non-woven fabric with ballistic characteristics is made up in closed damping cells to the kinetic energy of the bullet and to body temperature. The presentation of this product would be the same as that of non-woven fabrics (in rolls, in standard lengths, depending on each factory). Further when building in the membrane, the non-woven fabric does not lose any specific design features developed by Honeywell and it should be considered as one more non-woven fabric for the composition of a bulletproof vest.

The features of polyester foam membrane are set forth below

| Characteristics | Value | Standard |
|---|---|---|
| Cell structure | Closed | — |
| Thickness | 0.5 to 50 mm | — |
| Density | 20-35 kg m³ | ASTM D 1622 |
| Thermal conductivity | 0.035 to 0.045 W/m° C. | ASTM C518 |
| Water permeability | Watertight | Dir. UEAtc. |
| Water absorption | 1.2% V/V (42.6% P/P) | IRAM 1582 |
| Permeance to water | 0.033 g/m²hkPa | IRAM 1735 - |
| vapor | | ASTM E-96 |
| Insulation to impact | 19 dBA | IRAM 4063 Part |
| sounds | | V and VII |
| Dimensional stability | | |
| under heat | | |
| Longitudinal | −4.5/−4.2% | — |
| Transversal | +0.3/+0.8 (70° C. × 22 | — |
| | hours) | |
| Resistance to mineral oils | SAE 30 15 days 23° C. | — |
| Resistance to ozone | There is no cracking | ASTM D 1171 |
| Permeability to light rays | 52-63% | Spectrophotometer |

### 3) Axial Orientation of Fabrics

After preparing the fabric impregnated with resin and/or filler material, the cutting patterns must be finally placed so that the fibers in adjacent fabric layers form an angle between them, preferably oriented the following way: 0°/90°,0°/45°,0°/45°, 0°/90°. The available raw material (non-woven fabric), comes in rolls; their aramide fibers are either oriented parallel or perpendicular to the roll axis. Therefore, a square-shaped grid with fibers at right angles can be formed with these two types of fabrics. In order to obtain a different angle as desired, a method for the preparation of cutting patterns was necessary.

Once the roll of impregnated fabric is spread over the cutting table, and before cutting, such method consists in marking the patterns in angles of 45° thereby preparing patterns with their fibers oriented at angles of +45°/−45° for the subsequent manufacture of the vest, by superimposing intercrossed and non-intercrossed fabric layers. The only reference for movement is the marking of the patterns, since this is the only way to achieve the intercrossing of the fabric threads. By marking the patterns at 45° across the fabric that is spread over the cutting table, an intercrossing angle of 45° between the threads is achieved. Once all the sections of fabric spread over the cutting table has been marked, the fabric is cut in order to obtain the pieces of fabric or layers with the desired shape to manufacture the vest.

Thus, for each section of fabric spread over the cutting table, multiple vest panels are obtained, and depending of the location of the cutting tool or the type of cutting operation, vest panels with aramide fibers oriented at an angle of +45° and −45° with respect to the geometric longitudinal axis of the fabric are obtained. Therefore, the pieces cut from a first roll of aramide fiber fabric will be vest-shaped panels where the orientation of the fibers is of 0° and 90° with respect to the longitudinal geometrical axis of the fabric.

Then, the pieces cut from a second roll of aramide fiber fabric will be vest-shaped panels, where the orientation of the fibers is of +45° and −45° with respect to the longitudinal geometrical axis of the fabric. The multi-layer material of the invention is obtained by placing a vest-shaped panel obtained from the first fabric roll on top of a vest-shaped panel obtained from the second fabric roll, and so on until a multi-layer material is obtained, wherein the fibers in one fabric layer form a certain angle with respect to the fibers in the adjacent or neighboring fabric layers. It is important to understand that, since the fabric is manufactured with its fibers oriented at 0° and 90° (perpendicular to each other), and that there are no aramide fiber fabrics available with axial fibers oriented at +45° and −45°, the intercrossing's of the fibers at +45° and −45° must be achieved by biasing either the cutting tool or the fabric itself when cutting the modules. The cutting tool will be biased to an angle of 45° or any other desired angle, then vest-shaped panels with fibers oriented at +45° and −45° will be obtained, which when superimposed with adjacent fabric layers with fibers oriented at 0° and 90°, will form a material such as the one disclosed by the present invention. The material can be formed by 24-36-48 or more fabric layers, as may be needed.

By way of example, for a material comprising 24 fabric layers, there will be eight layers with fibers oriented at angles of 0°/90° (without biasing the cutting tool), eight fabric layers cut with the cutting tool biased to an angle of +45°, and eight fabric layers cut with the cutting tools biased to an angle of −45°.

The method is illustrated in detail in the figures, showing the way the garment-shaped fabric panels, for example, for a vest, are made, the method comprising the following steps:

a) Cutting a first piece of fabric with its fibers oriented in a first direction with a given cutting pattern;
b) Cutting a second piece of fabric with its fibers oriented in said first direction in a second direction different from that of the first cut, with the same cutting pattern;
c) Forming multiple fabric layers by superimposing consecutively a first fabric layer as cut in step “a” and a second fabric layer as cut in step “b”.

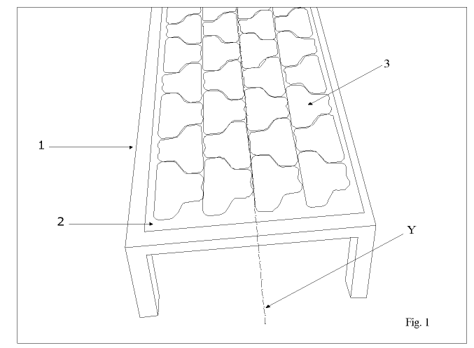

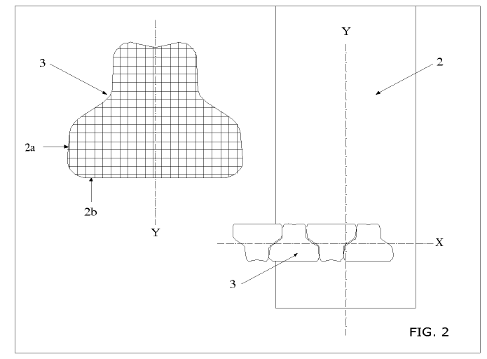

Referring now to the drawings, and more particularly FIG. 1, the present invention shows a cutting table 1 on which a fabric 2 is placed, with its geometric longitudinal axis Y, after being unrolled and which shall subsequently be cut into multiple vest-shaped fabric panels of the vest 3. Since the fabric is manufactured with its axial fibers oriented at angles of 0°-90°, any cut made with the corresponding cutting tools will give as a result a shaped fabric panel such as the one shown in FIG. 2.

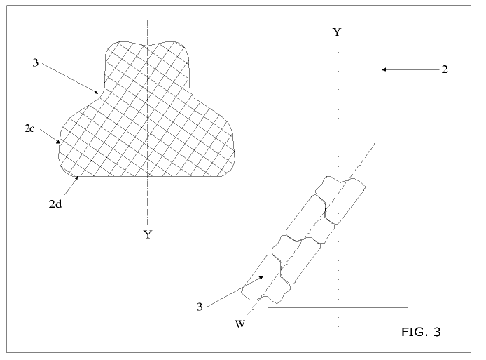

As for the manufacture of products such as body armors, security and sports protective garments according to the present invention it is necessary to count with fabric panels having their axial fibers oriented in an angle, and since there are no non-woven fabrics available with such a characteristic, the cutting tool must be biased properly in order to obtain said panels as shown in the drawings of FIGS. 3, 4 and 5.

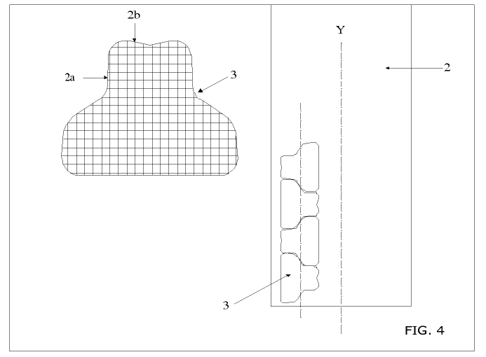

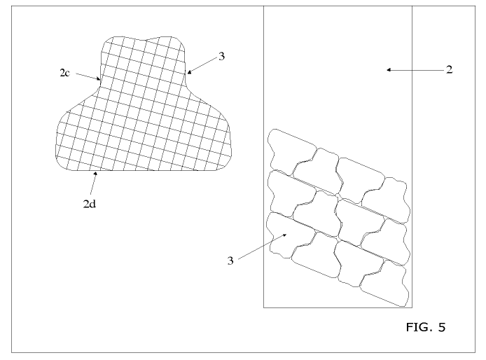

For example, the fabric panel of FIG. 2 with respect to both the longitudinal Y and Latitudinal X axes has its fibers 2a and 2b oriented orthogonal to each other and at an angle of 45° with respect to the fibers 2c and 2d which are also orthogonal to each other in the fabric panel of FIG. 3. Consequently, upon superimposing one over the other, a material such as the one disclosed herein will be obtained, i.e. having adjacent fabric layers with their respective fibers forming an angle therebetween. FIGS. 4 and 5 show further rotations of the fibers about both the longitudinal Y and Latitudinal X axes in a similar manner to that of FIGS. 2 and 3.

Obviously, whatever the bias angle given to the cutting tool, keeping the fabric in the same position on the cutting table, will give as a result a fabric panel having its fibers oriented at an angle with respect to the fibers in the original fabric of 0-90°.

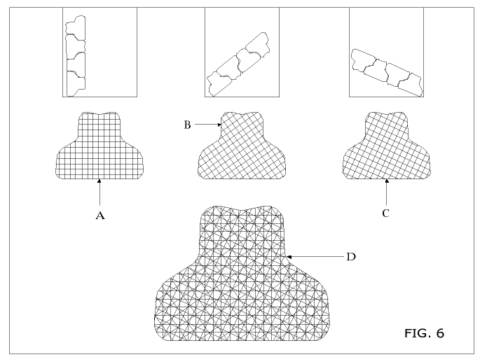

FIG. 6 illustrates in detail the weave of cutting patterns resulting from placing the non-woven fabric at angles of 90° (A), +45° (B) and −45° (C) and the multi-layer material (D) resulting from superimposing said fabric layers to manufacture a protective garment.

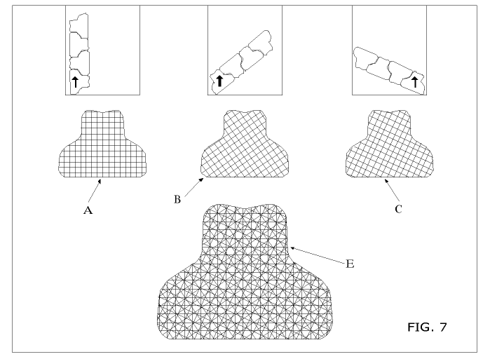

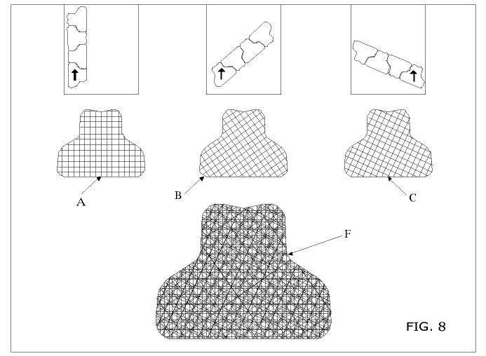

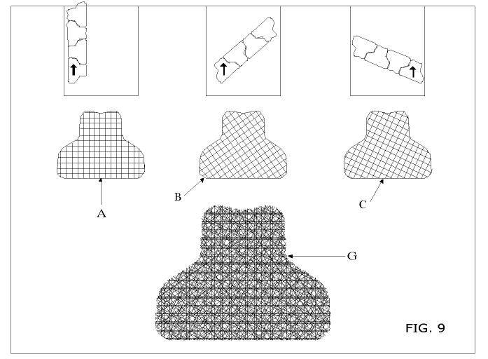

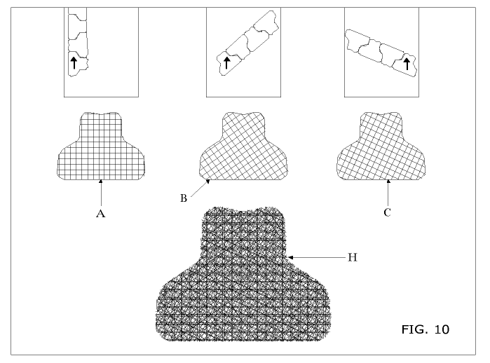

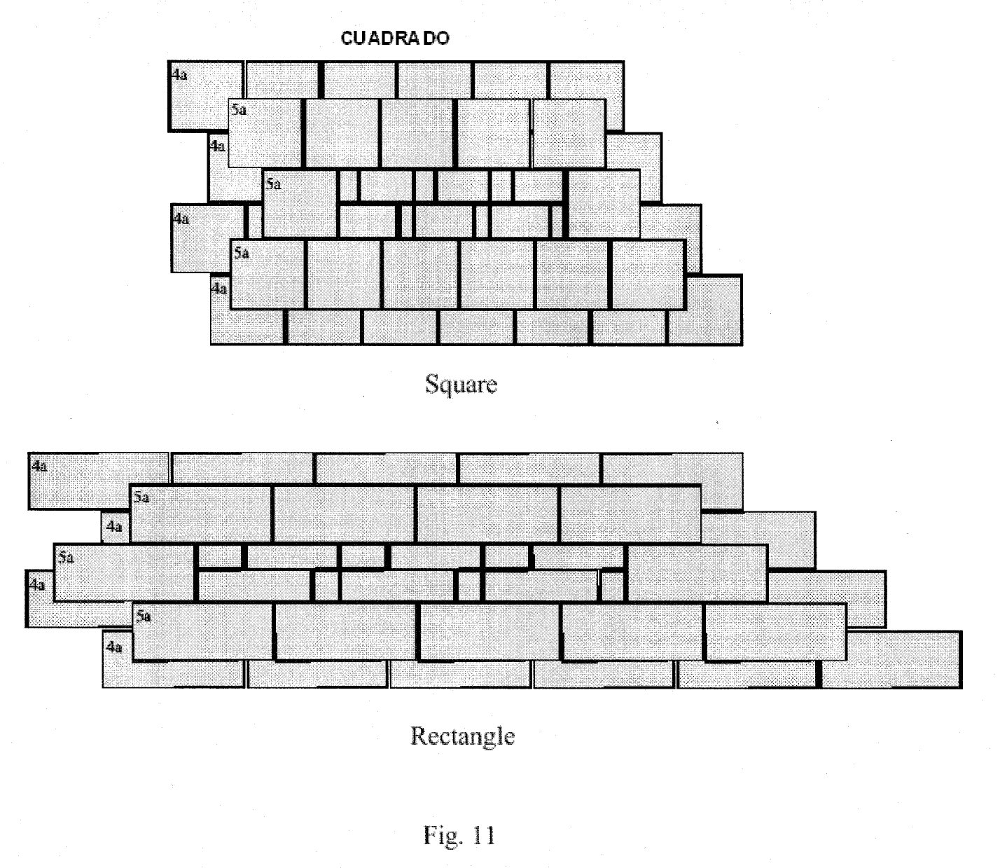

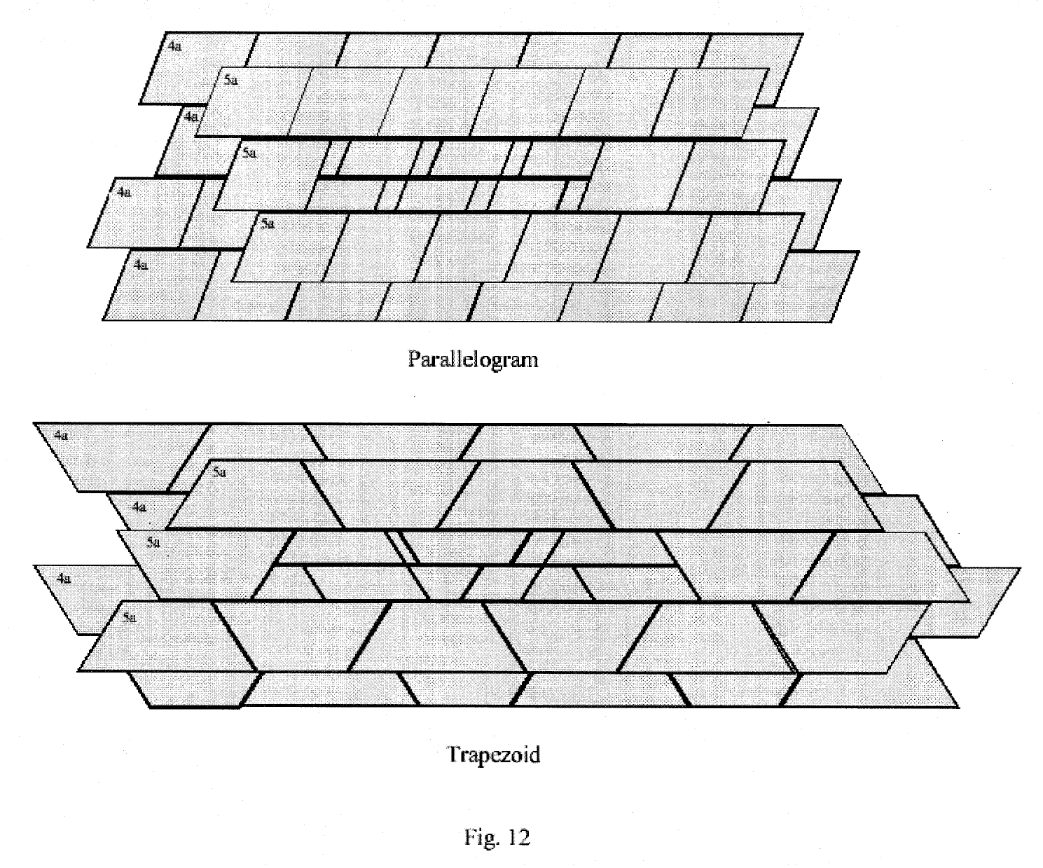

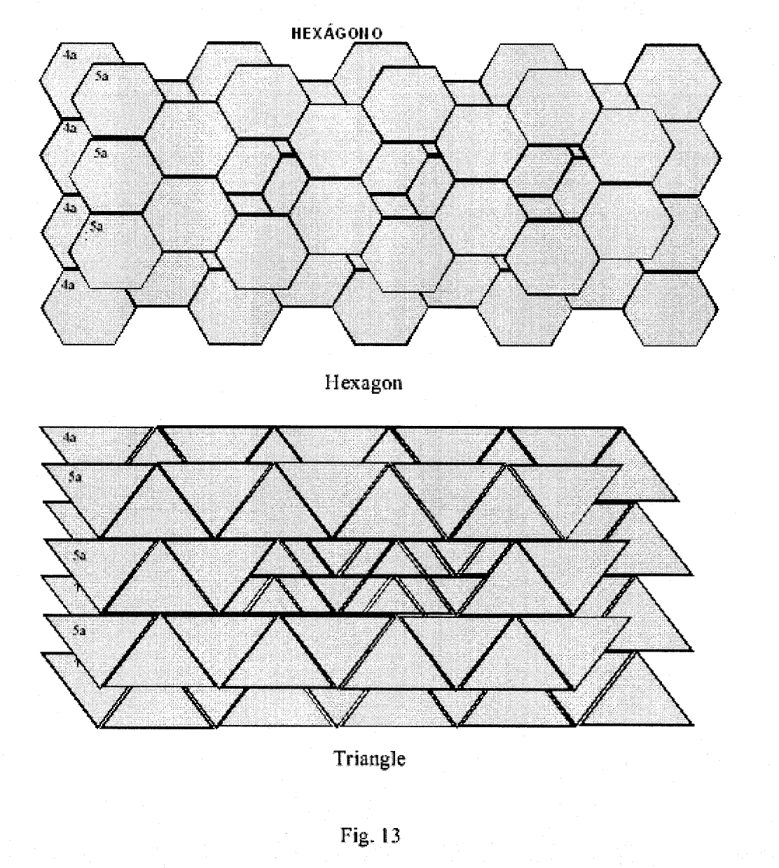

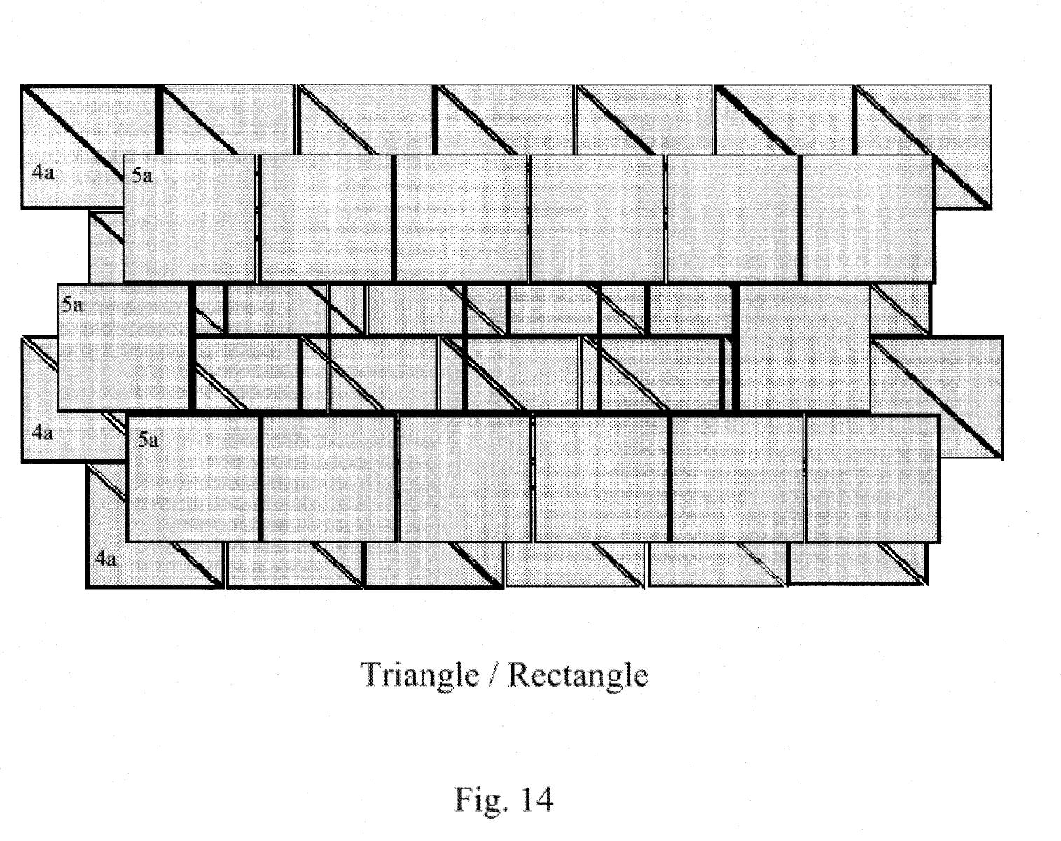

FIGS. 7 to 10 display the sequence of steps of displacing the roll of non-woven fabric along the longitudinal axis Y of the cutting table 1, at different angles (A), (B) and (C), and cutting the patterns in each of the positions, then obtaining a multi-layer material (E), (F), (G), and (H) respectively by superimposing the fabric panels obtained, which has a maximum level of fiber intercrossing and provides the highest degree of safety and protection.

FIGS. 11 to 14 show how the fabric layers, made up of various shapes of left over patterned material may be overlapped in a bottom layer 4a and a top layer 5a to form an alternate starting material to the prepreg for continued processing.

### Comparative Tests

### A) Ballistic Test

### B) Piercing and Stabbing Test

A) Ballistic results: This test was performed on two different materials. The first material was made by superimposing 30 non-woven fabric layers as manufactured (non traced fabrics). A second multi-layer material was made according to the present invention, and consisted of 30 non-woven fabric layers superimposed with the crossing angles mentioned above (traced fabrics).

Comparing the ballistic test results of traced fabrics (defined as those with fibers oriented at different angles) with those of non-traced fabrics (defined as those with fibers oriented at angles of 0/90° it can be observed that the projectiles, upon penetrating the multi-layer non-woven fabric material of the present invention, exhibit a greater degree of deformation, which means that the material made with traced fabrics of the present invention dissipates energy more efficiently than the material made with non traced fabrics. Such an improvement bears a direct relationship with the ballistic performance regarding penetration of a projectile, since it is observed that the projectile penetrates a lower number of layers, thus providing greater protection and safety to the user. The traumatic effect was reduced by 25% as compared to the results obtained with the original material, with fabrics intercrossed at angles of 0°/90°.

1) By incorporating resin on one side of the non-woven fabric, even better results are obtained regarding the deformation of incoming projectiles, number of layers penetrated, energy dissipation and displacement of threads in the area affected by the projectile. The use of these non-woven fabrics leads to a reduction of 36% in the traumatic effect as compared to standard fabrics with no intercrossing or impregnation.
2) By incorporating resin to both sides of the non-woven fabric used for the material of the invention, the results are even better, in terms of greater protection obtained from the non-woven fabrics, greater dissipation of kinetic energy and lower traumatic effect, thus providing greater protection as compared to the material made with fabrics which have been resin-impregnated on only one side, and leading to a traumatic reduction of 50%.

### B) Results of Piercing and Stabbing Tests

1) The original non-woven fabric as manufactured)(0°/90° is taken as a reference. Using same number of non-woven fabric layers the axial system with tracing was incorporated to the original non-woven fabric 0°/90° as produced by the manufacturer,
2) As mentioned above, Goldshield 2112/2115/2116/2117/2118/Spectra Shield SR 1224-Spectra Shield II 3124-3130, materials are compatible with our disclosure. But only when incorporating the tracing system we were able to obtain advantageous results regarding the performance against piercing and cutting objects as compared to the non-woven fabrics used in their original condition 0°/90°.
3) These parameters were tested and confirmed at three National Institute of Justice (NIJ) accredited HP White laboratories in the US under the NIJ-0.115.00 standard.
4) After confirming the validity of these results in this prestigious laboratory, we continued the development of the materials of the invention by incorporating the use of resins.
5) The incorporation of resins resulted in the obtaining of better results, in comparison to those described above. The resistance to penetration of piercing and cutting objects was improved, and the number of necessary non-woven fabric layers was significantly reduced.
6) By adding a filler material to the resin, even better results were obtained, since the number of non-woven fabric layers to achieve the same performance can be reduced even further. Therefore, by applying the three systems together: intercrossing of fibers, plus the use of resin, plus the incorporation of a filler material, the total number of non-woven fabric layers can be reduced by about 50%.

The foregoing discussion discloses and describes merely exemplary embodiments of the present invention. One skilled in the art will readily recognize from such discussion and from the accompanying drawings and claims, that various changes, modifications and variations can be made therein without departing from the spirit and scope of the invention as defined in the following claims.

1. A multilayer non-woven composite material incorporating an energy absorbing anti trauma foam membrane comprising:
a multitude of laminate layers comprising a multitude of unidirectional non woven fibers impregnated with bonding resin and filler;
an impregnating resin;
an impregnating filler;
a foam membrane backing; and
wherein said each of a multitude of laminate layers is comprised of unidirectionally oriented fibers are non woven and adhesively fixed with resin to retain their relative positions;
wherein said non woven resin fixed unidirectionally oriented fibers is further impregnated with filler material;
wherein said multitude of laminate layers are superimposed at varying degree angles relative to the first layer and non adhesively joined only at the perimeter; and
wherein said foam membrane backing is made of polyethylene and coated on one side with a very thin layer of aluminum polyester film or foil.

2. The composite of claim 1, wherein said each of a multitude of laminate layers is comprised of unidirectionaly oriented fibers that are dimensionally elongated in its length, being larger than the width transversal dimensions.

3. The composite of claim 1, wherein said non woven fiber is selected from the group consisting of aramide, ultra high molecular weight polyethylene, ultra high molecular weight polyolefin, and polybenzazole.

4. The composite of claim 1, wherein said non woven fiber has a tenacity of 23 g/denier.

5. The composite of claim 1, wherein said impregnating filler is selected from the group consisting of aluminum oxide, titanium oxide, carbon/boron oxide, silicon oxide, silicon dioxide, quartz oxide, silicon carbide, titanium carbide, and hard glass.

6. The composite of claim 1, wherein said impregnating filler is impregnated on both sides of said laminate layer to improve resistance to cutting and piercing objects.

7. The composite of claim 1, wherein said impregnating resin is selected from the group consisting of amines, cyanates, epoxies, phenols, esters, non saturated polyesters, bismaleimides, polyurethanes, silicones, and vinyl's.

8. The composite of claim 1, wherein a multitude of laminate layers are superimposed on each other at increasing angles of five degrees up to a maximum of ninety degrees relative to the first laminate layer.

9. The composite of claim 1, wherein said multitude of laminate layers are not adhesively bonded together and only joined at the perimeter to allow each adjacent layer to slide past each other to form a multilayer composite material.

10. The composite of claim 1, wherein said multilayer non woven composite material is resistant to cutting and piercing objects as well as ballistic projectiles.

11. The composite of claim 1, wherein said multilayer non woven composite material for piercing-proof garments has a range of two to ten laminate layers.

12. The composite of claim 1, wherein said multilayer non woven composite material for piercing-proof garments has a total area density of 234 g/m².

13. The composite of claim 1, wherein said multilayer non woven composite material for piercing-proof garments will withstand penetration of cutting and piercing objects in compliance with levels 1, 2, and 3, Spike P1, and S of the NIJ 0115.00 standard.

14. The composite of claim 1, wherein said multilayer non woven composite material for ballistic proof garments has a range of twenty to seventy five laminate layers.

15. The composite of claim 1, wherein said multilayer non woven composite material for ballistic proof garments has a total area density of 138±15 g/m².

16. The composite of claim 1, wherein said multilayer non woven composite material for ballistic proof garments will withstand penetration of bullets in compliance with protection levels IIA, II, IIIA of NIJ 0.101.06 standard.

17. A ballistic and stab resistant multilayer composite material for garments comprising:
a multitude of laminate layers joined only at the perimeter, each of the laminate layers comprising a multitude of resin impregnated unidirectional non woven fibers, each laminate layer being rotated (five degrees) from the first layer giving an average unidirectional fiber rotation of five degrees, each laminate layer being impregnated with a filler material to close the gap created by the rotation of the unidirectional fiber laminate layers; each laminate layer incorporating a foam membrane backing; wherein each said non woven laminate layer is superimposed so that the fibers in each layer form angles of 0°/90°, 0°/20°, 0°/25°, 0°/30°, 0°/35°, 0°/40°, 0°/45°, 0°/50°, 0°/55°, 0°/60°, 0°/65°, 0°/70°, 0°/75°, 0°/80°, with the fibers of the adjacent layer; and wherein said foam membrane backing is made of polyethylene and coated on one side with a very thin layer of aluminum polyester film or foil.

18. The composite of claim 17, wherein said laminate layer is comprised of unidirectionaly oriented non woven fibers that are dimensionally elongated in its length, being larger than the width transversal dimensions.

19. The composite of claim 17, wherein said non woven fibers are selected from the group consisting of aramide, ultra high molecular weight polyethylene, ultra high molecular weight polyolefin, and polybenzazole, and having a fiber tenacity of 23 g/denier.

20. The composite of claim 17, wherein said impregnating resin is selected from the group consisting of amines, cyanates, epoxies, phenols, esters, non saturated polyesters, bismaleimides, polyurethanes, silicones, and vinyl's.

21. The composite of claim 17, wherein said filler material is impregnated on both sides of said laminate layer and is selected from the group consisting of aluminum oxide, titanium oxide, carbon/boron oxide, silicon oxide, silicon dioxide, quartz oxide, silicon carbide, titanium carbide, and hard glass.

22. The composite of claim 17, wherein said multilayer composite material is resistant to cutting and piercing objects as well as ballistic projectiles.

23. The composite of claim 17, wherein said multilayer composite material for ballistic resistant garments has a total area density of 138±15 g/m²; and wherein said multilayer composite material for piercing resistant garments has a total area density of 234 g/m².

24. The composite of claim 17, wherein said multilayer composite material for piercing-proof garments has a range of two to ten laminate layers.

25. The composite of claim 17, wherein said multilayer composite material for ballistic proof garments has a range of twenty to seventy five laminate layers.

26. The composite of claim 17, wherein said multilayer composite material for piercing resistant garments will withstand penetration of cutting and piercing objects in compliance with levels 1, 2, and 3, Spike P1, and S1 of the NIJ 0115.00 standard; and wherein said multilayer composite material for ballistic resistant garments will withstand penetration of bullets in compliance with protection levels IIA, II, IIIA of NIJ 0.101.06 standard.
